(19) United States
(12) Patent Application Publication
(10) Pub. No.: US 2025/0310759 A1
(43) Pub. Date: Oct. 2, 2025

(54) HANDLING SECURITY KEYS FOR LAYER 1 TRIGGERED MOBILITY

(71) Applicant: Samsung Electronics Co., Ltd., Suwon-si (KR)

(72) Inventors: Anil Agiwal, McKinney, TX (US); Shiyang Leng, Allen, TX (US); Kyeongin Jeong, Allen, TX (US)

(21) Appl. No.: 19/084,696

(22) Filed: Mar. 19, 2025

Related U.S. Application Data
(60) Provisional application No. 63/572,700, filed on Apr. 1, 2024.
(60) Provisional application No. 63/717,511, filed on Nov. 7, 2024.

(51) Int. Cl. H04W 12/041; H04W 12/033; H04W 12/30

(52) U.S. Cl. CPC H04W 12/041; H04W 12/033; H04W 12/30

(57) ABSTRACT

A method of operating a UE includes receiving, from a source BS, an RRC reconfiguration message that includes a list of at least one NCC for LTM, receiving, from the source BS, an LTM cell switch command to switch to an LTM target cell, and deriving a security key for a BS of the LTM target cell based on an NCC in a first entry of the list of at least one NCC for LTM. The method also includes updating the list of at least one NCC for LTM by removing the NCC in the first entry, and deriving, from the security key for the BS of the LTM target cell, RRC and user plane encryption and integrity protection keys for securing RRC and user plane data transmitted to and received from the LTM target cell.

### CROSS-REFERENCE TO RELATED APPLICATIONS AND CLAIM OF PRIORITY

This application claims priority under 35 U.S.C. § 119(e) to U.S. Provisional Patent Application No. 63/572,700 filed on Apr. 1, 2024, and U.S. Provisional Patent Application No. 63/717,511 filed on Nov. 7, 2024. The above-identified provisional patent applications are hereby incorporated by reference in their entirety.

### TECHNICAL FIELD

This disclosure relates generally to wireless networks. More specifically, this disclosure relates to handling security keys for layer 1 triggered mobility (LTM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for handling security keys for LTM.

In one embodiment, a user equipment (UE) is provided. The UE includes a transceiver configured to receive, from a source base station (BS), a radio resource control (RRC) reconfiguration message that includes a list of at least one next hop chaining counter (NCC) for lower layer triggered mobility (LTM), and receive, from the source BS, an LTM cell switch command to switch to an LTM target cell. The UE also includes a processor operably coupled to the transceiver. The processor is configured to, in response to receipt of the LTM cell switch command, derive a security key for a BS of the LTM target cell based on an NCC in a first entry of the list of at least one NCC for LTM, update the list of at least one NCC for LTM by removing the NCC in the first entry, and derive, from the security key for the BS of the LTM target cell, RRC and user plane encryption and integrity protection keys for securing RRC and user plane data transmitted to and received from the LTM target cell.

In another embodiment, a source BS is provided. The source BS includes a transceiver configured to receive, from an access and mobility function (AMF), a list of at least one NCC and next hop (NH) pair for LTM, and transmit, transmit, to a UE, an LTM cell switch command to switch to an LTM target cell. The source BS also includes a processor operably coupled to the transceiver. The processor is configured to select a NH from a first entry in the list of at least one NCC and NH pair for LTM, derive a security key for a BS of the LTM target cell based on the selected NH, and in response to transmission of the LTM cell switch command to the UE, cause the transceiver to transmit, to the BS of the LTM target cell, the derived security key for the BS of the LTM target cell. The derived security key for the BS of the LTM target cell is for derivation of, by the LTM target cell, RRC and user plane encryption and integrity protection keys used to protect RRC and user plane data transmitted to and received from the UE.

In yet another embodiment, a method of operating a UE is provided. The method includes receiving, from a source BS, an RRC reconfiguration message that includes a list of at least one NCC for LTM, receiving, from the source BS, an LTM cell switch command to switch to an LTM target cell, and deriving a security key for a BS of the LTM target cell based on an NCC in a first entry of the list of at least one NCC for LTM. The method also includes updating the list of at least one NCC for LTM by removing the NCC in the first entry, and deriving, from the security key for the BS of the LTM target cell, RRC and user plane encryption and integrity protection keys for securing RRC and user plane data transmitted to and received from the LTM target cell.

In still another embodiment, a method of operating a source BS is provided. The method includes receiving, from an AMF, a list of at least one NCC and NH pair for LTM, and transmitting, to a UE, an LTM cell switch command to switch to an LTM target cell. The method also includes selecting a NH from a first entry in the list of at least one NCC and NH pair for LTM, deriving a security key for a BS of the LTM target cell based on the selected NH, and in response to transmission of the LTM cell switch command to the UE, transmitting, to the BS of the LTM target cell, the derived security key for the BS of the LTM target cell. The derived security key for the BS of the LTM target cell is for derivation of, by the LTM target cell, RRC and user plane encryption and integrity protection keys used to protect RRC and user plane data transmitted to and received from the UE.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example NG-RAN overall architecture according to embodiments of the present disclosure;

FIG. 4B illustrates an example architecture for gNB-CU-CP and gNB-CU-UP separation according to embodiments of the present disclosure;

FIG. 5 illustrates example signaling procedures for inter-gNB handover according to embodiments of the present disclosure;

FIG. 6 illustrates an example procedure for LTM according to embodiments of the present disclosure;

FIG. 7 illustrates another example procedure for LTM according to embodiments of the present disclosure;

FIG. 8 illustrates another example procedure for LTM according to embodiments of the present disclosure;

FIG. 9 illustrates another example procedure for LTM according to embodiments of the present disclosure;

FIG. 10 illustrates another example procedure for LTM according to embodiments of the present disclosure;

FIG. 11 illustrates another example procedure for LTM according to embodiments of the present disclosure;

FIG. 12 illustrates an example procedure for inter RAT LTM according to embodiments of the present disclosure;

FIG. 13 illustrates an example early TA procedure applicable for any type of cell switch according to embodiments of the present disclosure;

FIG. 14 illustrates an example method for handling security keys for LTM according to embodiments of the present disclosure; and

FIG. 15 illustrates another example method for handling security keys for LTM according to embodiments of the present disclosure.

### DETAILED DESCRIPTION

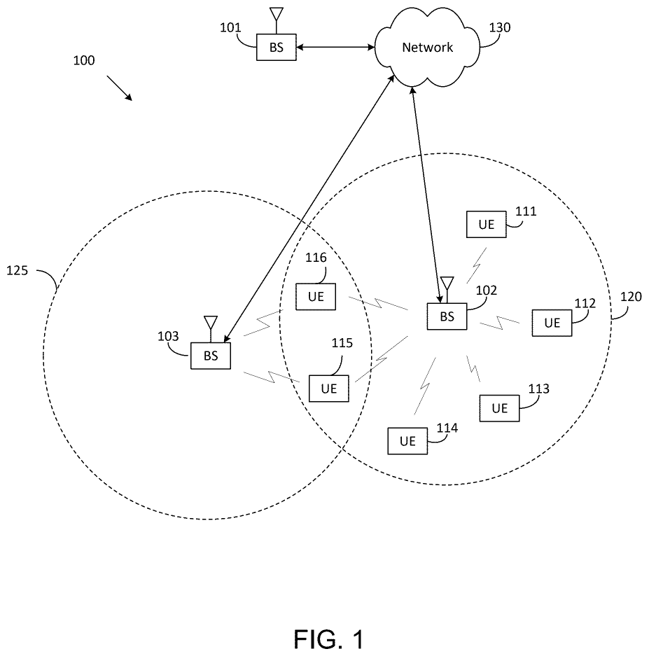

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for handling security keys for LTM. In certain embodiments, one or more of the gNBs 101-103 includes circuitry, programing, or a combination thereof, to support handling security keys for LTM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

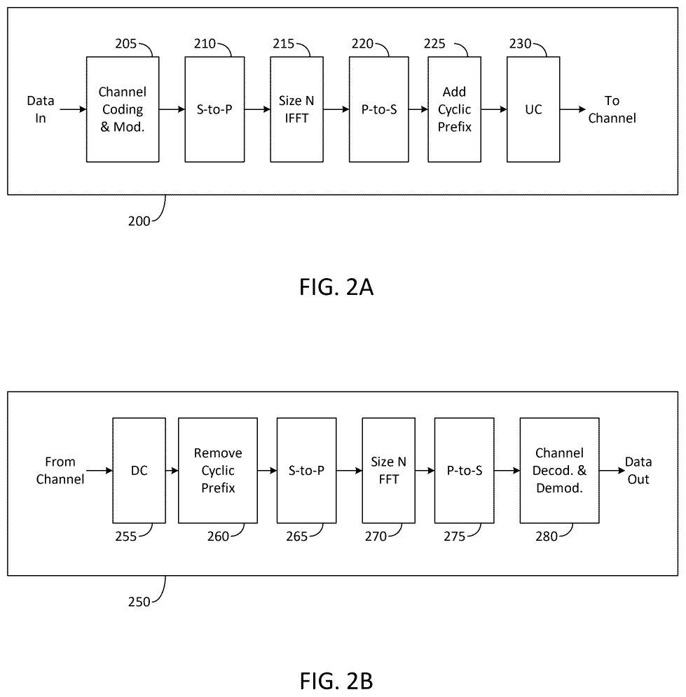

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support handling security keys for LTM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

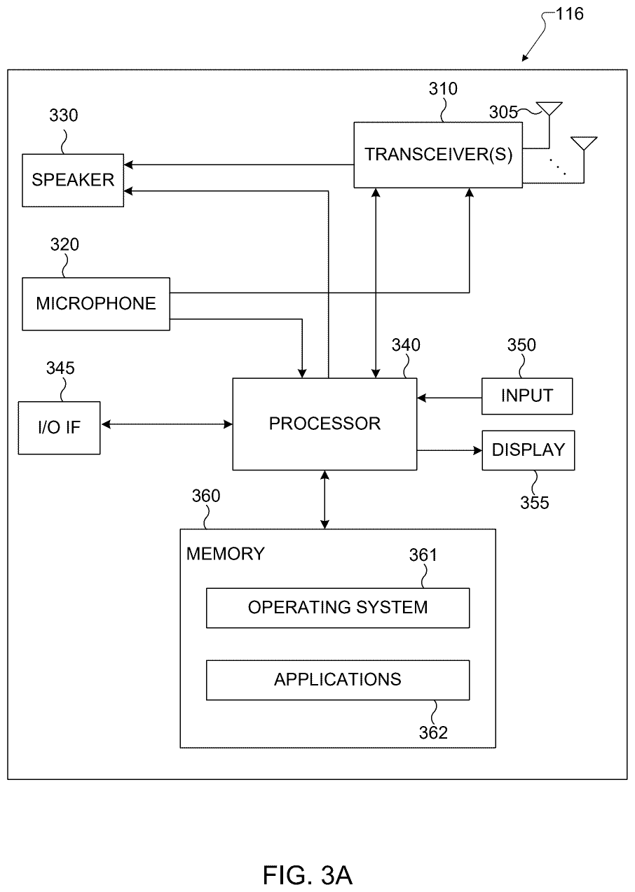

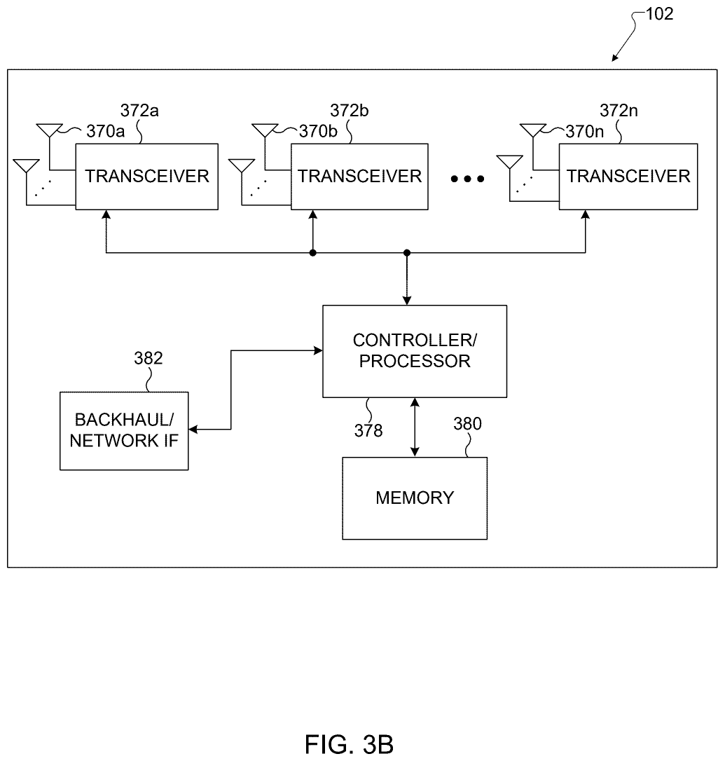

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for handling security keys for LTM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support handling security keys for LTM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise, the term Special Cell refers to the PCell.

In the next generation wireless communication system (e.g., 5G, beyond 5G, 6G), a node B (gNB) or base station in cell broadcast Synchronization Signal and PBCH (SS/PBCH) block (SSB), includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured Control REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signalling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

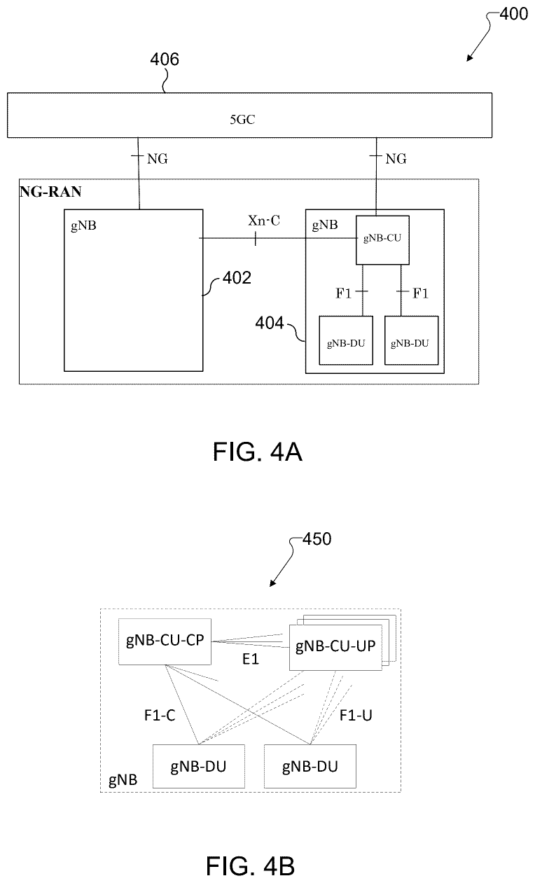

FIG. 4A illustrates an example next generation radio access network (NG-RAN) overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

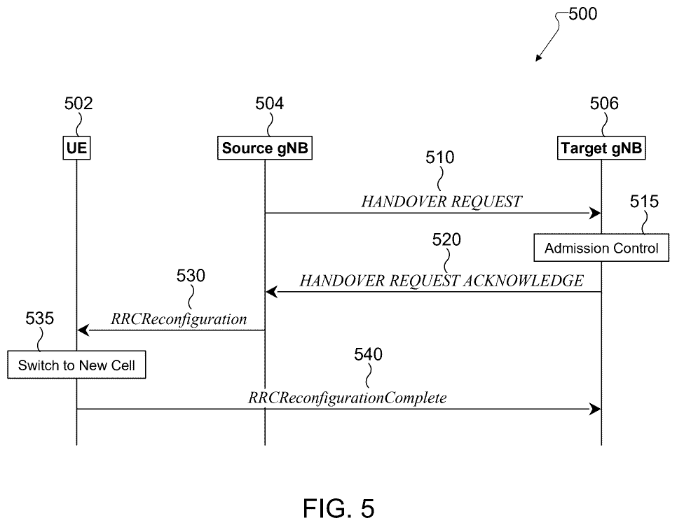

In the next generation wireless communication system (e.g., 5G, beyond 5G, 6G), cell level mobility and beam level mobility are supported. Cell Level Mobility is triggered by explicit RRC signaling (i.e., handover signaling). For inter-gNB handover, the signaling procedures comprise at least the following elemental components as shown in FIG. 5.

FIG. 5 illustrates example signaling procedures 500 for inter-gNB handover according to embodiments of the present disclosure. An embodiment of the signaling procedures illustrated in FIG. 5 are for illustration only. One or more of the components illustrated in FIG. 5 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 5, source gNB 504 initiates handover and issues a HANDOVER REQUEST 510 over an Xn interface to a target gNB 506. Target gNB performs admission control at step 515 and provides a new RRC configuration as part of a HANDOVER REQUEST ACKNOWLEDGE 520. Source gNB 504 provides the RRC configuration to UE 502 by forwarding the RRCReconfiguration message 530 received in the HANDOVER REQUEST ACKNOWLEDGE 520. The RRCReconfiguration message 530 includes at least cell ID and all information required to access the target cell so that the UE 502 can access the target cell without reading system information. For some cases, the information required for contention-based and contention-free random access can be included in RRCReconfiguration message 530. The access information to the target cell may include beam specific information, if any. At step 535, UE 502 moves the RRC connection to target gNB 506 and replies with the RRCReconfigurationComplete message 540. The example of FIG. 5 may be referred to as a network controlled or network initiated handover procedure.

Although FIG. 5 illustrates one example of signaling procedures 500 for inter-gNB handover, various changes may be made to FIG. 5. For example, while shown as a series of steps, various steps in FIG. 5 could overlap, occur in parallel, occur in a different order, occur any number of times, be omitted, or replaced by other steps.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a medium access control (MAC) control element (CE). The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early timing advance (TA) acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. The UE may monitor the PDCCH for dynamic scheduling from the target cell upon an LTM cell switch.

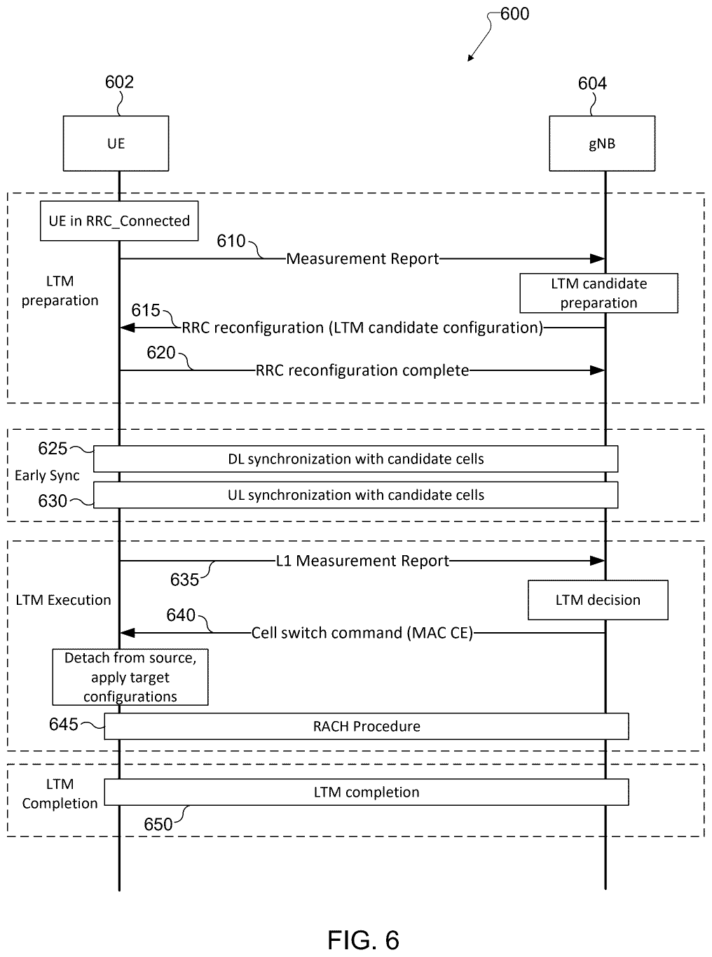

FIG. 6 illustrates an example procedure 600 for LTM according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 6, procedure 600 begins at operation 610. At operation 610, UE 602, which is in an RRC connected state sends a MeasurementReport message to gNB 604. gNB 604 then decides to configure LTM and initiates candidate cell(s) preparation.

At operation 615, gNB 604 transmits an RRCReconfiguration message to UE 602 including the LTM candidate cell configurations of one or multiple candidate cells.

At operation 620, UE 602 stores the LTM candidate cell configurations and transmits an RRCReconfigurationComplete message to gNB 604.

At operation 625, UE 602 may perform DL synchronization with the candidate cell(s) before receiving a cell switch command.

At operation 630, if requested by the network, UE 602 performs early TA acquisition with the candidate cell(s) before receiving the cell switch command. This is done via contention free random access (CFRA) triggered by a PDCCH order from the source cell, following which UE 602 sends a preamble towards the indicated candidate cell. In order to minimize the data interruption of the source cell due to the CFRA towards the candidate cell(s), UE 602 doesn't receive a RAR for the purpose of TA value acquisition and the TA value of the candidate cell is indicated in the cell switch command. UE 602 doesn't maintain the TA timer for the candidate cell and relies on network implementation to guarantee the TA validity.

At operation 635, UE 602 performs L1 measurements on the configured candidate cell(s) and transmits L1 measurement reports to the gNB.

At operation 640, gNB 404 decides to execute cell switch to a target cell and transmits a MAC CE triggering cell switch by including the candidate configuration index of the target cell. UE 602 switches to the target cell and applies the configuration indicated by the candidate configuration index.

At operation 645, UE 602 performs a random access procedure towards the target cell if UE does not have valid TA of the target cell.

At operation 650, UE 602 completes the LTM cell switch procedure by sending a RRCReconfigurationComplete message to the target cell. If UE 602 has performed a RA procedure in operation 645, UE 602 considers that the LTM execution is successfully completed when the random access procedure is successfully completed. For RACH-less LTM, UE 602 considers that the LTM execution is successfully completed when the UE determines that the network has successfully received its first UL data. UE 602 determines successful reception of its first UL data by receiving a PDCCH addressing UE 602's C-RNTI in the target cell, which schedules a new transmission following the first UL data.

Although FIG. 6 illustrates one example procedure 600 for LTM, various changes may be made to FIG. 6. For example, while shown as a series of operations, various operations in FIG. 6 could overlap, occur in parallel, occur in a different order, occur any number of times, be omitted, or replaced by other operations.

In the next generation wireless communication system (e.g., 5G, beyond 5G, 6G), an LTM cell switch from a first cell to a second cell is supported when the first cell and second cell belong to the same CU. During such an LTM cell switch, security keys are not changed/updated.

For a legacy network controlled handover (where the network sends a handover command as in FIG. 5) or conditional handover (CHO), whether to update security keys is indicated by signaling a masterKeyUpdate IE in an RRCReconfiguration message. The masterKeyUpdate includes a nextHopChainingCount (NCC). If the NCC received is not identical to an NCC corresponding to the current security key KgNB, the UE derives a security key KgNB* using a next hop (NH) corresponding to the received NCC. This is also referred as vertical key derivation. If the NCC received is identical to the NCC corresponding to the current security key KgNB, the UE derives the security key KgNB* using KgNB. The UE then derives RRC and user plane encryption and integrity protection keys from KgNB* which are used in a new cell (i.e., target cell).

Because some LTM procedures do not change/update the security keys, LTM cell switch is not supported by theses LTM procedures when the first cell and second cell belong to different CUs. Various embodiments of the present disclosure provide security key update procedures to support inter CU LTM.

In some embodiments, a masterKeyUpdate IE can be included in an LTM-Candidate Cell configuration, and an inter CU LTM may be performed as follows:
A first cell (“Cell 1”) may serve as a current serving cell for a UE. Cell 1 belongs to a first CU (“CU 1”).
The UE may receive an RRCReconfiguration message with LTM candidate cells “Cell 2”, “Cell 3”, and “Cell 4.”
   Cell 2 belongs to CU1 and Cell 3 and Cell 4 belongs to second CU (“CU2”). The candidate configurations of Cell 3 and Cell 4 can include a masterKeyUpdate, while a masterKeyUpdate is not included in the candidate configuration of Cell 2.
The UE may receive an LTM cell switch command to switch from Cell 1 to Cell 3
   The UE updates the security key based on the masterKeyUpdate.

The above scenario will work if a subsequent LTM cell switch without RRCReconfiguration is not supported. However, the above approach will not work for a subsequent LTM cell switch without reconfiguration. For example, if another LTM cell switch command is received to switch from Cell 3 to Cell 4 after switching from Cell 1 to Cell 3, the UE will update the security key based on the masterKeyUpdate in the candidate configuration of Cell 4. This is not correct. A security key update should not be performed, because Cell 3 and Cell 4 belong to the same CU. Various embodiments of the present disclosure provide security key update procedures to support subsequent LTM cell switch without reconfiguration.

For LTM, the network may indicate one or more L1 measurement based events based on which a UE may initiate LTM execution to a candidate LTM cell without receiving a cell switch command from the gNB. This procedure may be referred to as conditional LTM or UE initiated LTM. A list of one or more candidate LTM cells for conditional LTM or UE initiated LTM may be signaled by the gNB in an RRCReconfiguration message (i.e., operation 615 of FIG. 6).

In the next generation wireless communication system (e.g., 5G, beyond 5G, 6G), early UL sync is supported for intra and inter CU LTM. An early UL sync configuration is included as part of the LTM candidate configuration and is signaled to the UE using an RRCReconfiguration message. A PDCCH order is used to trigger a RA for early UL sync. The PDCCH order indicates an SSB, dedicated preamble, UL carrier and candidate cell. Early UL sync is not supported for other mobility procedures such as conditional handover and L3 handover. A TA acquired for an LTM candidate cell cannot be applied for the same candidate cell for UE initiated mobility such as CHO. Various embodiments of the present disclosure provide procedures for early TA acquisition which may be applied to any type of cell switch.

LTM was introduced to reduce the latency of legacy handover. Key components of LTM which help in reducing latency are early UL sync and early configuration of candidate cell configurations. In future wireless communication systems, a typical deployment may comprise both 5G and 6G cells, and should support mobility between the 5G and 6G cells (i.e., inter RAT mobility). One possible approach for inter RAT mobility is for the network to support inter RAT handover between 5G and 6G cells similar to legacy inter RAT handover between 4G and 5G. However, this leads to increased handover interruption time. Inter RAT LTM can reduce latency. Various embodiments of the present disclosure provide procedures to support inter RAT LTM.

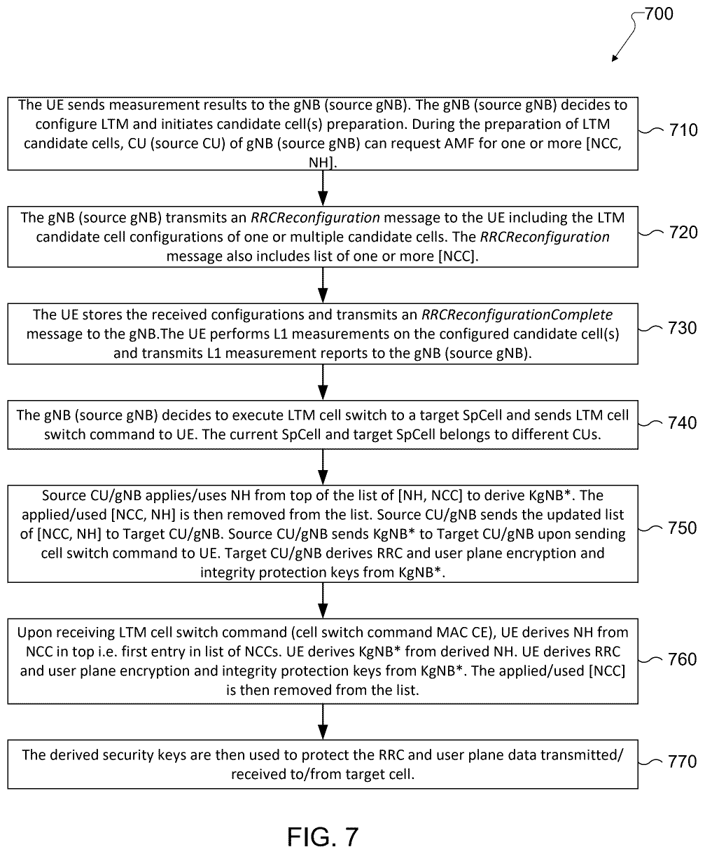

FIG. 7 illustrates another example procedure 700 for LTM according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 7, procedure 700 begins at operation 710. At operation 710, a UE (such as UE 602 of FIG. 6) sends measurement results to a gNB (e.g., a source gNB, such as gNB 604 of FIG. 6). The gNB (source gNB) decides to configure LTM and initiates candidate cell(s) preparation. In some embodiments, during the preparation of LTM candidate cells, the CU (e.g., a source CU) of the gNB (source gNB) can request for one or more NCC and NH pairs from an access and mobility function (AMF), and the AMF provides the one or more NCC and NH pairs (i.e., as a list) in response. Alternately, in some embodiments, the CU of the LTM candidate cells can request for one or more NCC and NH pairs from the AMF, and the AMF provides the one or more NCC and NH pairs (i.e., as a list) to the CU (source CU) of the gNB (source gNB).

At operation 720, the gNB (source gNB) transmits an RRCReconfiguration message to the UE including the LTM candidate cell configurations of one or multiple candidate cells. The RRCReconfiguration message also includes a list of one or more NCCs. The list of one or more NCCs are received the by the gNB (source gNB) as in operation 710 (i.e., the NCCs are from the list of one or more NCC and NH pairs provided by the AMF).

At operation 730, the UE stores the received configurations and transmits an RRCReconfigurationComplete message to the gNB. Afterward, the UE performs L1 measurements on the configured candidate cell(s) and transmits L1 measurement reports to the gNB (source gNB). In some embodiments, the UE may perform DL synchronization with the candidate cell(s) before receiving a cell switch command (e.g., at operation 740). In some embodiments, if requested by the network, the UE performs early TA acquisition with the candidate cell(s) before receiving a cell switch command (e.g., at operation 740). The early TA acquisition is performed via a CFRA triggered by a PDCCH order from the source cell, following which the UE sends a preamble towards the indicated candidate cell. In order to minimize the data interruption of the source cell due to the CFRA towards the candidate cell(s), the UE doesn't receive a RAR for the purpose of TA value acquisition, and the TA value of the candidate cell is indicated in the cell switch command. The UE doesn't maintain the TA timer for the candidate cell and relies on network implementation to guarantee the TA validity.

At operation 740, the gNB (source gNB) decides to execute an LTM cell switch to a target SpCell and sends an LTM cell switch command to the UE. The current SpCell and target SpCell belong to different CUs. For inter CU LTM, the network can indicate in the LTM cell switch command to update security keys in the cell switch command, or the network can include a security update ID in the LTM candidate cell configuration and a security update ID in the LTM configuration for the current serving cell. If the security update ID for the current serving cell is different from the security update ID in the LTM candidate cell configuration of the target cell, the UE updates the security keys. Otherwise, the UE does not update the security keys. If the security keys are to be updated, the UE and network derive the security keys to be used in the target cell according to operations 750 and 760.

At operation 750, the source CU/gNB applies/uses the NH from the top of the list of NCC and NH pairs (i.e., the first entry in the list of NCC and NH pairs) to derive KgNB*. The applied/used NCC and NH pair is then removed from the list. The source CU/gNB sends the updated list of NCC and NH pairs to the target CU/gNB. The source CU/gNB sends KgNB* to the target CU/gNB before sending or upon sending the cell switch command to the UE. The target CU/gNB derives RRC and user plane encryption and integrity protection keys from KgNB*.

At operation 760, upon receiving the LTM cell switch command (e.g., a cell switch command MAC CE), the UE derives the NH from the NCC at the top of a list of NCCs (i.e., the first entry in the list of NCCs). The UE derives KgNB* from the derived NH. The UE derives RRC and user plane encryption and integrity protection keys from KgNB*. The applied/used NCC is then removed from the list.

In some embodiments, if the list of NCCs (or NCC and NH pairs) is empty, the source CU/gNB/UE can derive KgNB* using horizontal key derivation (i.e., from the current KgNB), and the UE derives RRC and user plane encryption and integrity protection keys from KgNB*.

At operation 770, the derived security keys are then used to protect the RRC and user plane data transmitted to and received from the target cell.

Although FIG. 7 illustrates one example procedure 700 for LTM, various changes may be made to FIG. 7. For example, while shown as a series of operations, various operations in FIG. 7 could overlap, occur in parallel, occur in a different order, occur any number of times, be omitted, or replaced by other operations.

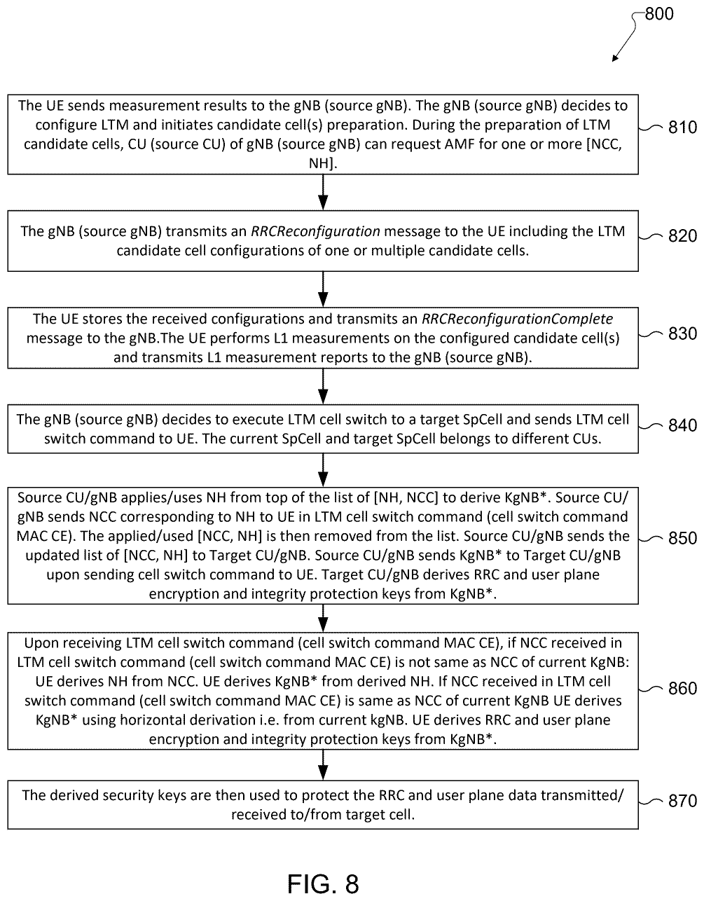

FIG. 8 illustrates another example procedure 800 for LTM according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 8, procedure 800 begins at operation 810. At operation 810, a UE (such as UE 602 of FIG. 6) sends measurement results to a gNB (e.g., a source gNB, such as gNB 604 of FIG. 6). The gNB (source gNB) decides to configure LTM and initiates candidate cell(s) preparation. In some embodiments, during the preparation of LTM candidate cells, the CU (e.g., a source CU) of the gNB (source gNB) can request for one or more NCC and NH pairs from an access and mobility function (AMF), and the AMF provides the one or more NCC and NH pairs (i.e., as a list) in response. Alternately, in some embodiments, the CU of the LTM candidate cells can request for one or more NCC and NH pairs from the AMF, and the AMF provides the one or more NCC and NH pairs (i.e., as a list) to the CU (source CU) of the gNB (source gNB).

At operation 820, the gNB (source gNB) transmits an RRCReconfiguration message to the UE including the LTM candidate cell configurations of one or multiple candidate cells.

At operation 830, the UE stores the received configurations and transmits an RRCReconfigurationComplete message to the gNB. Afterward, the UE performs L1 measurements on the configured candidate cell(s) and transmits L1 measurement reports to the gNB (source gNB). In some embodiments, the UE may perform DL synchronization with the candidate cell(s) before receiving a cell switch command (e.g., at operation 840). In some embodiments, if requested by the network, the UE performs early TA acquisition with the candidate cell(s) before receiving a cell switch command (e.g., at operation 840). The early TA acquisition is performed via a CFRA triggered by a PDCCH order from the source cell, following which the UE sends a preamble towards the indicated candidate cell. In order to minimize the data interruption of the source cell due to the CFRA towards the candidate cell(s), the UE doesn't receive a RAR for the purpose of TA value acquisition, and the TA value of the candidate cell is indicated in the cell switch command. The UE doesn't maintain the TA timer for the candidate cell and relies on network implementation to guarantee the TA validity.

At operation 840, the gNB (source gNB) decides to execute an LTM cell switch to a target SpCell and sends an LTM cell switch command to the UE. The current SpCell and target SpCell belong to different CUs.

At operation 850, the source CU/gNB applies/uses the NH from the top of the list of NCC and NH pairs to derive KgNB*. The applied/used NCC and NH pair is then removed from the list. The source CU/gNB sends the NCC corresponding to the NH applied/used to derive KgNB* to the UE in the LTM cell switch command of operation 840 (e.g., in a cell switch command MAC CE). The source CU/gNB sends the updated list of NCC and NH pairs to the target CU/gNB. If the list of NCCs or NCC and NH pairs is empty, the source CU/gNB/UE can derive KgNB* using horizontal key derivation (i.e., from the current KgNB). RRC and user plane encryption and integrity protection keys can be derived from KgNB*. The Source CU/gNB sends an NCC corresponding to the current KgNB to the UE in the LTM cell switch command of operation 840 (cell switch command MAC CE). The source CU/gNB sends KgNB* to the target CU/gNB before sending or upon sending the cell switch command to the UE. The target CU/gNB derives RRC and user plane encryption and integrity protection keys from KgNB*.

At operation 860, upon receiving the LTM cell switch command (cell switch command MAC CE), if the NCC received in the LTM cell switch command (cell switch command MAC CE) is not identical to the NCC of the current KgNB, the UE derives a NH corresponding to the NCC received in the LTM cell switch command. The UE derives KgNB* from the derived NH. The UE derives RRC and user plane encryption and integrity protection keys from KgNB*. Otherwise, if the NCC received in the LTM cell switch command (cell switch command MAC CE) is identical to the NCC of the current KgNB, the UE derives KgNB* using horizontal derivation (i.e., from the current kgNB). The UE derives RRC and user plane encryption and integrity protection keys from KgNB*.

At operation 870, the derived security keys are then used to protect the RRC and user plane data transmitted to and received from the target cell. If the security key is updated during the LTM cell switch, the UE also performs PDCP re-establishment. In some embodiments, a separate indication to indicate PDCP re-establishment for an inter CU LTM switch may not be used.

Although FIG. 8 illustrates one example procedure 800 for LTM, various changes may be made to FIG. 8. For example, while shown as a series of operations, various operations in FIG. 8 could overlap, occur in parallel, occur in a different order, occur any number of times, be omitted, or replaced by other operations.

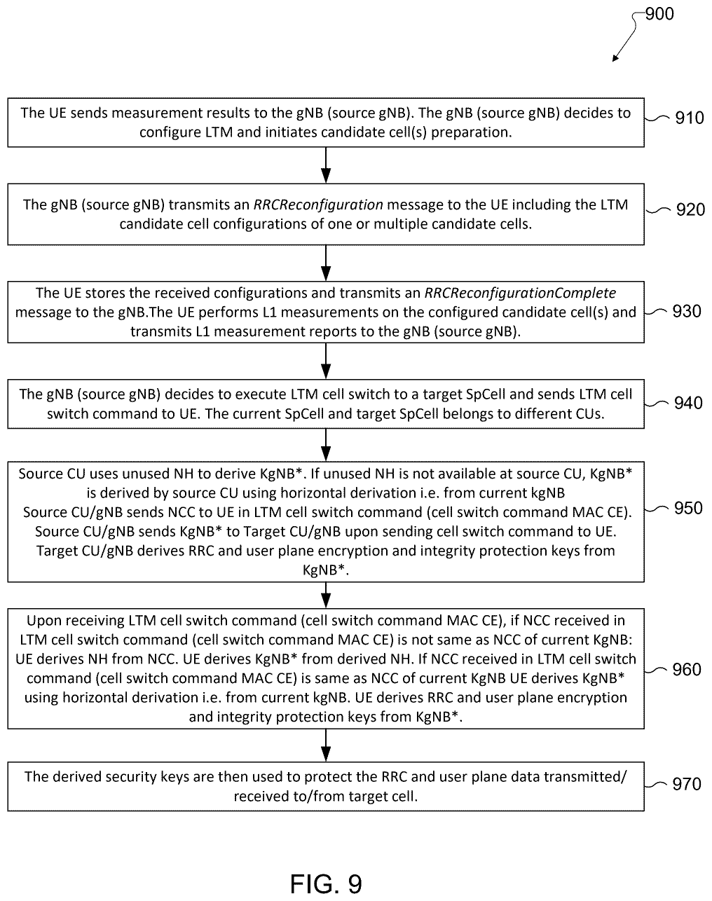

FIG. 9 illustrates another example procedure 900 for LTM according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 9, procedure 900 begins at operation 910. At operation 910, a UE (such as UE 602 of FIG. 6) sends measurement results to a gNB (e.g., a source gNB, such as gNB 604 of FIG. 6). The gNB (source gNB) decides to configure LTM and initiates candidate cell(s) preparation.

At operation 920, the gNB (source gNB) transmits an RRCReconfiguration message to the UE including the LTM candidate cell configurations of one or multiple candidate cells.

At operation 930, the UE stores the received configurations and transmits an RRCReconfigurationComplete message to the gNB (source gNB). Afterward, the UE performs L1 measurements on the configured candidate cell(s) and transmits L1 measurement reports to the gNB (source gNB). In some embodiments, the UE may perform DL synchronization with the candidate cell(s) before receiving a cell switch command (e.g., at operation 940). In some embodiments, if requested by the network, the UE performs early TA acquisition with the candidate cell(s) before receiving a cell switch command (e.g., at operation 940). The early TA acquisition is performed via a CFRA triggered by a PDCCH order from the source cell, following which the UE sends a preamble towards the indicated candidate cell. In order to minimize the data interruption of the source cell due to the CFRA towards the candidate cell(s), the UE doesn't receive a RAR for the purpose of TA value acquisition, and the TA value of the candidate cell is indicated in the cell switch command. The UE doesn't maintain the TA timer for the candidate cell and relies on network implementation to guarantee the TA validity.

At operation 940, the gNB (source gNB) decides to execute an LTM cell switch to a target SpCell and sends an LTM cell switch command to the UE. The current SpCell and target SpCell belong to different CUs. For inter CU LTM, the network can indicate (e.g., via inclusion of an NCC) in the LTM cell switch command to update security keys, or the network can include a security update ID in the LTM candidate cell configuration and a security update ID in the LTM configuration for the current serving cell. If the security update ID for the current serving cell is different from the security update ID in the LTM candidate cell configuration of the target cell, the UE updates the security keys. Otherwise, the UE does not update the security keys. If the security keys are to be updated, the UE and network derive the security keys to be used in the target cell according to operations 950 and 960.

At operation 950, the source CU uses an unused NH to derive KgNB*. The source CU/gNB sends an NCC corresponding to the NH or the current KgNB to the UE in the LTM cell switch command (e.g., a cell switch command MAC CE) of operation 940. If an unused NH is not available at the source CU, KgNB* is derived by the source CU using horizontal derivation (i.e., from the current KgNB). The Source CU/gNB sends an NCC corresponding to the current KgNB to the UE in the LTM cell switch command (cell switch command MAC CE) of operation 940. The source CU/gNB sends KgNB* to the target CU/gNB before sending or upon sending the cell switch command to the UE. The target CU/gNB derives RRC and user plane encryption and integrity protection keys from KgNB*.

At operation 960, upon receiving the LTM cell switch command (cell switch command MAC CE), if the NCC received in the LTM cell switch command (cell switch command MAC CE) is not identical to the NCC of the current KgNB, the UE derives an NH corresponding to the NCC received in the LTM cell switch command. The UE derives KgNB* from the derived NH. The UE derives RRC and user plane encryption and integrity protection keys from KgNB*. Otherwise, if the NCC received in the LTM cell switch command (cell switch command MAC CE) is identical to the NCC of the current KgNB, the UE derives KgNB* using horizontal derivation (i.e., from the current KgNB). The UE derives RRC and user plane encryption and integrity protection keys from KgNB*. The ttarget CU receives an NCC and NH pair from an AMF upon cell switch for a subsequent switch.

At operation 970, the derived security keys are then used to protect the RRC and user plane data transmitted to and received from the target cell. If the security key is updated during the LTM cell switch, the UE also performs PDCP re-establishment. In some embodiments, a separate indication to indicate PDCP re-establishment for an inter CU LTM switch may not be used.

Although FIG. 9 illustrates one example procedure 900 for LTM, various changes may be made to FIG. 9. For example, while shown as a series of operations, various operations in FIG. 9 could overlap, occur in parallel, occur in a different order, occur any number of times, be omitted, or replaced by other operations.

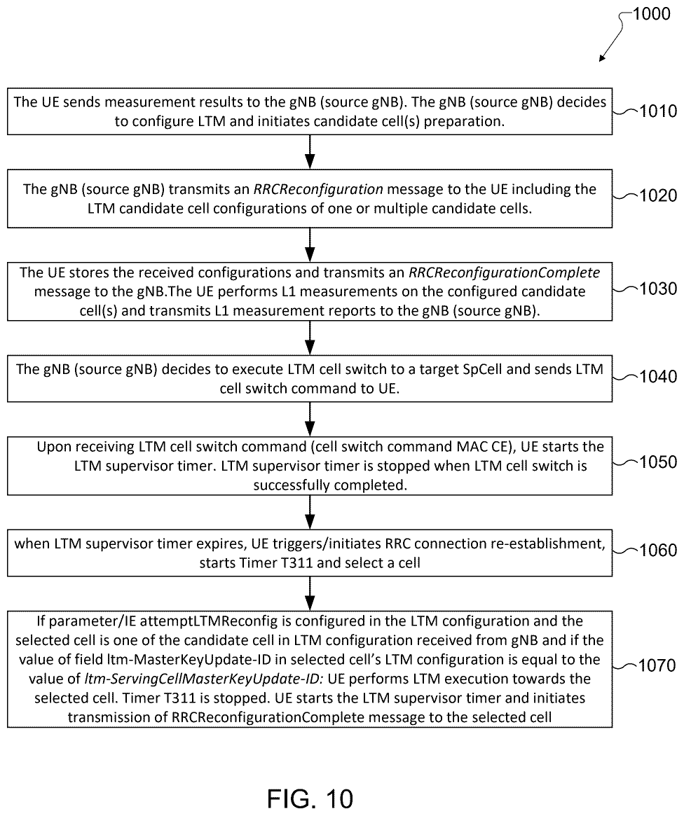

FIG. 10 illustrates another example procedure 1000 for LTM according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 10, procedure 1000 begins at operation 1010. At operation 1010, a UE (such as UE 602 of FIG. 6) sends measurement results to a gNB (e.g., a source gNB, such as gNB 604 of FIG. 6). The gNB (source gNB) decides to configure LTM and initiates candidate cell(s) preparation.

At operation 1020, the gNB (source gNB) transmits an RRCReconfiguration message to the UE including the LTM candidate cell configurations of one or multiple candidate cells. ltm-MasterKeyUpdate-ID-r19 and ltm-ServingCellMasterKeyUpdate-ID-r19 can be configured as shown below:

```
LTM-Candidate-r18 ::=  SEQUENCE {
  ltm-CandidateId-r18 LTM-CandidateId-r18,
  ltm-CandidatePCI-r18 PhysCellId,
  ltm-SSB-Config-r18 LTM-SSB-Config-
r18 OPTIONAL, -- Need M
  ltm-CandidateConfig-r18 OCTET STRING (CONTAINING
RRCReconfiguration) OPTIONAL, -- Need M
  ltm-ConfigComplete-r18 ENUMERATED
{true} OPTIONAL, -- Need R
  ltm-EarlyUL-SyncConfig-r18 SetupRelease { EarlyUL-SyncConfig-r18
} OPTIONAL, -- Need M
  Itm-EarlyUL-SyncConfigSUL-r18 SetupRelease { EarlyUL-SyncConfig-r18
} OPTIONAL, -- Need M
  ltm-NoResetID-r18 INTEGER (1..maxNrofLTM-Configs-r18-plus-
1) OPTIONAL, -- Need M
  ltm-DL-OrJointTCI-StateToAddModList-r18  SEQUENCE (SIZE
(1..maxNrofCandidateTCI-State-r18)) OF CandidateTCI-State-r18
                                                    OPTIONAL, -- Need N
  ltm-DL-OrJointTCI-StateToReleaseList-r18  SEQUENCE (SIZE
(1..maxNrofCandidateTCI-State-r18)) OF TCI-StateId
                                                    OPTIONAL, -- Need N
  ltm-UL-TCI-StatesToAddModList-r18 SEQUENCE (SIZE (1..maxNrofCandidateUL-
TCI-r18)) OF CandidateTCI-UL-State-r18
                                                    OPTIONAL, -- Need N
  ltm-UL-TCI-StatesToReleaseList-r18 SEQUENCE (SIZE (1..maxNrofCandidateUL-
TCI-r18)) OF TCI-UL-StateId-r17
                                                    OPTIONAL, -- Need N
  ltm-nzp-CSI-RS-ResourceToAddModList-r18  SEQUENCE (SIZE (1..maxNrofNZP-CSI-
RS-Resources)) OF NZP-CSI-RS-Resource
                                                    OPTIONAL, -- Need N
  ltm-nzp-CSI-RS-ResourceToReleaseList-r18  SEQUENCE (SIZE (1..maxNrofNZP-CSI-
RS-Resources)) OF NZP-CSI-RS-ResourceId
                                                    OPTIONAL, -- Need N
  ltm-nzp-CSI-RS-ResourceSetToAddModList-r18 SEQUENCE (SIZE (1..maxNrofNZP-
CSI-RS-ResourceSets)) OF NZP-CSI-RS-ResourceSet
                                                    OPTIONAL, -- Need N
  ltm-nzp-CSI-RS-ResourceSetToReleaseList-r18 SEQUENCE (SIZE (1..maxNrofNZP-CSI-
RS-ResourceSets)) OF NZP-CSI-RS-ResourceSetId
                                                    OPTIONAL, -- Need N
  pathlossReferenceRS-ToAddModList-r18 SEQUENCE (SIZE
(1..maxNrofPathlossReferenceRSs-r17)) OF PathlossReferenceRS-r17
                                                    OPTIONAL, -- Need N
  pathlossReferenceRS-ToReleaseList-r18 SEQUENCE (SIZE
(1..maxNrofPathlossReferenceRSs-r17)) OF PathlossReferenceRS-Id-r17
                                                    OPTIONAL, -- Need N
  ltm-UE-MeasuredTA-ID-r18  INTEGER (1..maxNrofLTM-Configs-r18-plus-
1) OPTIONAL, -- Need M
  ...,
  [[
    ltm-MasterKeyUpdate-ID-r19 INTEGER (1..maxNrofLTM-Configs-r18-plus-
1) OPTIONAL,
  ]]
}
LTM-Config-r18 ::= SEQUENCE {
  ltm-ReferenceConfiguration-r18 SetupRelease { ReferenceConfiguration-
r18} OPTIONAL, -- Need M
  ltm-CandidateToReleaseList-r18  SEQUENCE (SIZE (1..maxNrofLTM-Configs-r18)) OF
LTM-CandidateId-r18 OPTIONAL, -- Need N
  ltm-CandidateToAddModList-r18 SEQUENCE (SIZE (1..maxNrofLTM-Configs-r18))
OF LTM-Candidate-r18  OPTIONAL, -- Need N
  ltm-ServingCellNoResetID-r18 INTEGER (1..maxNrofLTM-Configs-r18-plus-
1) OPTIONAL, -- Cond FirstLTM-Only
  ltm-CSI-ResourceConfigToAddModList-r18 SEQUENCE (SIZE (1..maxNrofLTM-CSI-
ResourceConfigurations-r18)) OF LTM-CSI-ResourceConfig-r18
                                                      OPTIONAL, -- Need N
  ltm-CSI-ResourceConfigToReleaseList-r18 SEQUENCE (SIZE (1..maxNrofLTM-CSI-
ResourceConfigurations-r18)) OF LTM-CSI-ResourceConfigId-r18
                                                      OPTIONAL, -- Need N
  attemptLTM-Switch-r18 ENUMERATED
{true} OPTIONAL, -- Cond LTM-MCG
  ltm-ServingCellUE-MeasuredTA-ID-r18 INTEGER (1..maxNrofLTM-Configs-r18-
plus-1) OPTIONAL, -- Cond LTM
  ...,
  [[
    ltm-ServingCellMasterKeyUpdate-ID-r19 INTEGER (1..maxNrofLTM-
Configs-r18-plus-1) OPTIONAL,
  ]]
}
```

Cells belonging to the same CU can be configured with the same ltm-MasterKeyUpdate-ID. Cells belonging to a different CU can be configured with a different ltm-MasterKeyUpdate-ID. ltm-MasterKeyUpdate-ID-r19 and ltm-ServingCellMasterKeyUpdate-ID-r19 can also be referred to as ltm-SecurityKeyUpdate-ID-r19 and ltm-ServingCellSecurityKeyUpdate-ID-r19.

At operation 1030, the UE stores the received configurations and transmits an RRCReconfigurationComplete message to the gNB (source gNB). Afterward, the UE performs L1 measurements on the configured candidate cell(s) and transmits L1 measurement reports to the gNB (source gNB). In some embodiments, the UE may perform DL synchronization with the candidate cell(s) before receiving a cell switch command (e.g., at operation 1040). In some embodiments, if requested by the network, the UE performs early TA acquisition with the candidate cell(s) before receiving a cell switch command (e.g., at operation 1040). The early TA acquisition is performed via a CFRA triggered by a PDCCH order from the source cell, following which the UE sends a preamble towards the indicated candidate cell. In order to minimize the data interruption of the source cell due to the CFRA towards the candidate cell(s), the UE doesn't receive a RAR for the purpose of TA value acquisition, and the TA value of the candidate cell is indicated in the cell switch command. The UE doesn't maintain the TA timer for the candidate cell and relies on network implementation to guarantee the TA validity.

At operation 1040, the gNB (source gNB) decides to execute an LTM cell switch to a target SpCell and sends an LTM cell switch command to the UE.

At operation 1050, the UE starts the LTM supervisor timer. The LTM supervisor timer is stopped when the LTM cell switch is successfully completed.

At operation 1060, when the LTM supervisor timer expires (or when an RLF timer expires; or upon a random access problem indication from a MCG MAC while neither T300, T301, T304, T311 nor T319, or LTM supervision timers are running and SDT procedure is not ongoing; or upon indication from an MCG RLC that the maximum number of retransmissions has been reached while SDT procedure is not ongoing; or upon consistent uplink LBT failure indication from MCG MAC while T304 and LTM supervision timers are not running; or upon detection of radio link failure; or if LTM cell switch is considered failed [e.g., due to TCI state/RS {e.g., SSB/CSI RS/TRS} indicated by UE is not suitable {i.e., its RSRP/RSRQ is less/less than equal to a configured threshold}]), the UE triggers/initiates an RRC connection re-establishment and starts Timer T311. While T311 is running, the UE performs cell selection and selects a suitable NR cell.

In some embodiments, at operation 1070:
if a parameter/IE attemptLTMReconfig is configured (or attemptLTMReconfig is configured and set to TRUE) in the LTM configuration and the selected cell is one of the candidate cells in the LTM configuration received from the gNB (source gNB) and if the value of field ltm-MasterKeyUpdate-ID in the selected cell's LTM configuration is equal to the value of ltm-ServingCellMasterKeyUpdate-ID (i.e., the selected cell belongs to the same CU/gNB as the CU/gNB of the current serving cell/SpCell), the UE performs LTM execution towards the selected cell. Timer T311 is stopped. The UE starts the LTM supervisor timer and initiates transmission of an RRCReconfigurationComplete message to the selected cell (i.e., the UE performs an LTM cell switch towards the selected cell). The UE uses the current RRC and user plane encryption and integrity protection keys used in the current serving cell/SpCell in the selected cell.
Otherwise, T311 is stopped. T301 is started. The UE initiates transmission of the RRCReestablishmentRequest message towards the selected cell or initiates conditional handover towards the selected cell if conditional handover configuration is available/received in the RRCReconfiguration for the selected cell.

Alternatively, in some embodiments, at operation 1070:
If a parameter/IE attemptLTMReconfig is configured (or attemptLTMReconfig is configured and set to TRUE) in the LTM configuration and the selected cell is one of the candidate cells in the LTM configuration received from the gNB (source gNB) and if the value of the field ltm-MasterKeyUpdate-ID in the selected cell's LTM configuration is not equal to the value of ltm-ServingCellMasterKeyUpdate-ID (i.e., the selected cell belongs to a different CU/gNB as the CU/gNB of the current serving cell/SpCell), the UE performs LTM execution towards the selected cell. Timer T311 is stopped. The UE starts the LTM supervisor timer and initiates transmission of an RRCReconfigurationComplete message to the selected cell (i.e., the UE performs LTM cell switch towards the selected cell). The UE derives KgNB* from the current KgNB. The UE derives RRC and user plane encryption and integrity protection keys from KgNB*. The UE uses the derived RRC and user plane encryption and integrity protection keys in the selected cell. Upon receiving a C-RNTI MAC CE during the random access procedure for cell switch, the selected cell can determine that this cell switch was initiated by the UE and request KgNB* from the serving cell.
If a parameter/IE attemptLTMReconfig is configured (or attemptLTMReconfig is configured and set to TRUE) in the LTM configuration and the selected cell is one of the candidate cells in the LTM configuration received from the gNB (source gNB) and if the value of the field ltm-MasterKeyUpdate-ID in the selected cell's LTM configuration is equal to the value of ltm-ServingCellMasterKeyUpdate-ID (i.e., the selected cell belongs to the same CU/gNB as the CU/gNB of the current serving cell/SpCell), the UE performs LTM execution towards the selected cell. Timer T311 is stopped. The UE starts the LTM supervisor timer and initiates transmission of an RRCReconfigurationComplete message to the selected cell (i.e., the UE performs an LTM cell switch towards the selected cell). The UE uses the current RRC and user plane encryption and integrity protection keys used in the current serving cell/SpCell in the selected cell.
Otherwise, T311 is stopped. T301 is started. The UE initiates transmission of the RRCReestablishmentRequest message towards the selected cell or initiates a conditional handover towards the selected cell if a conditional handover configuration is available/received in the RRCReconfiguration for the selected cell.

Although FIG. 10 illustrates one example procedure 1000 for LTM, various changes may be made to FIG. 10. For example, while shown as a series of operations, various operations in FIG. 10 could overlap, occur in parallel, occur in a different order, occur any number of times, be omitted, or replaced by other operations.

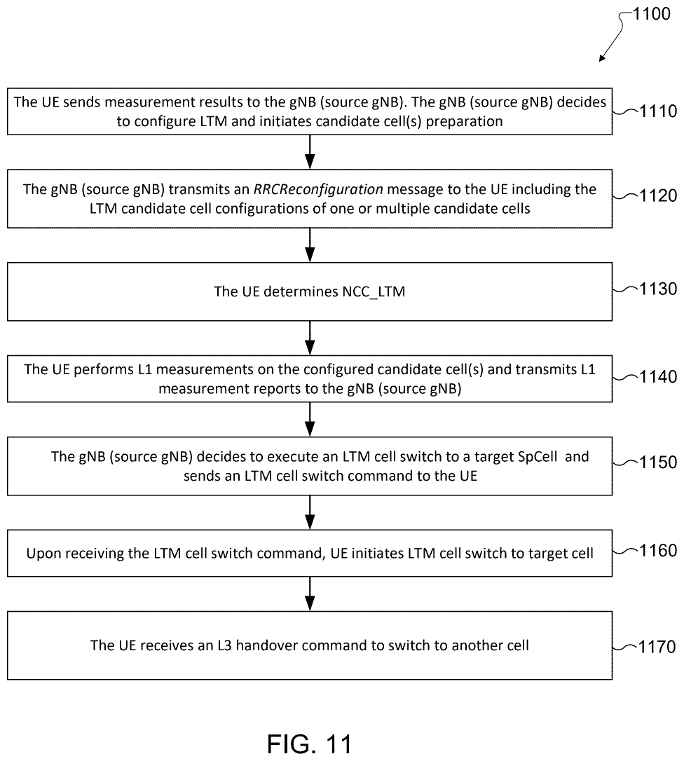

FIG. 11 illustrates another example procedure 1100 for LTM according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 11, a UE (such as UE 602 of FIG. 6) is in an RRC CONNECTED state. The UE is communicating with a serving cell/SpCell “Cell 1”. The serving cell belongs to a gNB/CU1 (such as gNB 604 of FIG. 6). The UE is using RRC and user plane encryption and integrity protection keys derived from KgNB. This KgNB is associated with an NCC.

Procedure 1100 begins at operation 1110. At operation 1110, the UE sends measurement results to the gNB (source gNB). The gNB (source gNB) decides to configure LTM and initiates candidate cell(s) preparation.

At operation 1120, the gNB (source gNB) transmits an RRCReconfiguration message to the UE including the LTM candidate cell configurations of one or multiple candidate cells.

At operation 1130, upon receiving the LTM configuration, the UE determines the NCC for the LTM cell switch with security key update. The NCC for the LTM cell switch with security key update can be referred to as NCC_LTM.

In some embodiments, the LTM configuration may include an NCC. If an NCC is included in the LTM configuration, upon receiving the LTM configuration, the UE sets NCC_LTM to the NCC value received in the LTM configuration. If the gNB (source gNB) has an unused NH, the gNB (source gNB) includes the NCC of this unused NH in the LTM configuration. Otherwise, the gNB (source gNB) includes the NCC of the currently used KgNB key.

Alternatively, in some embodiments, the UE sets NCC_LTM to the NCC of the currently used KgNB key+1.

In some embodiments, whenever (e.g., during a layer 3 [L3] handover) KgNB is updated using vertical key derivation, the UE may set NCC_LTM to the NCC of the newly derived KgNB key+1. The NCC of the newly derived KgNB key is the NCC received in the handover command (i.e., RRCReconfiguration with reconfigurationwithsync IE). This assumes that during a L3 handover with vertical key update, upon handover the gNB receives a new NH for a subsequent handover from the AMF. Alternatively, in some embodiments, NCC_LTM is updated and set to the NCC of the newly derived KgNB key (i.e., the NCC received in the handover command). After handover, if the target receives a new NH from the AMF, the target can provide the NCC of the new NH to the UE (e.g., in an LTM configuration), and the UE will set NCC_LTM to the received value.

In some embodiments, whenever (e.g., during a L3 handover) KgNB is updated, the UE may set NCC_LTM to the NCC of the newly derived KgNB key+1. The NCC of the newly derived KgNB key is the NCC received in the handover command (i.e., a RRCReconfiguration with reconfigurationwithsync IE).

At operation 1140, the UE performs L1 measurements on the configured candidate cell(s) and transmits L1 measurement reports to the gNB (source gNB).

At operation 1150, the gNB (source gNB) decides to execute an LTM cell switch to a target SpCell “Cell 2” and sends an LTM cell switch command to the UE. Cell 2 belongs to a second CU “CU2”.

At operation 1160, upon receiving the LTM cell switch command, the UE initiates an LTM cell switch to the target cell. If a security key update is needed (indicated in the cell switch command or if the value of the field ltm-MasterKeyUpdate-ID in the target cell's LTM configuration is not equal to the value of ltm-ServingCellMasterKeyUpdate-ID [i.e., the target cell does not belong to the same CU/gNB as the CU/gNB of current serving cell/SpCell]):
If NCC_LTM is identical to the NCC of the currently used KgNB, the UE derives KgNB* using horizontal derivation (i.e., from the current KgNB). The UE derives RRC and user plane encryption and integrity protection keys from KgNB*. NCC_LTM is not updated.
If NCC_LTM is not identical to the NCC of the currently used KgNB, the UE derives KgNB* using the NH corresponding to NCC_LTM. The UE derives RRC and user plane encryption and integrity protection keys from KgNB* NCC_LTM is then updated and set to NCC LTM+1.
   The UE uses the RRC and user plane encryption and integrity protection keys derived from KgNB* in the switched cell (i.e., Cell 2). KgNB* becomes the KgNB of Cell 2. If the security key is updated during the LTM Cell switch, the UE also performs PDCP re-establishment. In some embodiments, a separate indication to indicate PDCP re-establishment for an inter CU LTM switch may not be used.

At operation 1170, the UE receives an L3 handover command to switch to another cell “Cell 3” from Cell 2. Cell 3 belongs to a third CU “CU3”. The L3 handover command includes an NCC which is different from the NCC of the KgNB used in Cell 2. The UE derives KgNB* using the NH corresponding to the NCC received in handover command. The UE derives RRC and user plane encryption and integrity protection keys from KgNB*. In some embodiments, NCC_LTM is then updated and set to the NCC of newly derived KgNB key+1 (i.e., the NCC received in the handover command+1). Alternatively, in some embodiments, NCC_LTM is updated and set to the NCC of the newly derived KgNB key (i.e., the NCC received in the handover command [i.e., RRCReconfiguration with reconfigurationwithsync IE]).

Although FIG. 11 illustrates one example procedure 1100 for LTM, various changes may be made to FIG. 11. For example, while shown as a series of operations, various operations in FIG. 11 could overlap, occur in parallel, occur in a different order, occur any number of times, be omitted, or replaced by other operations.

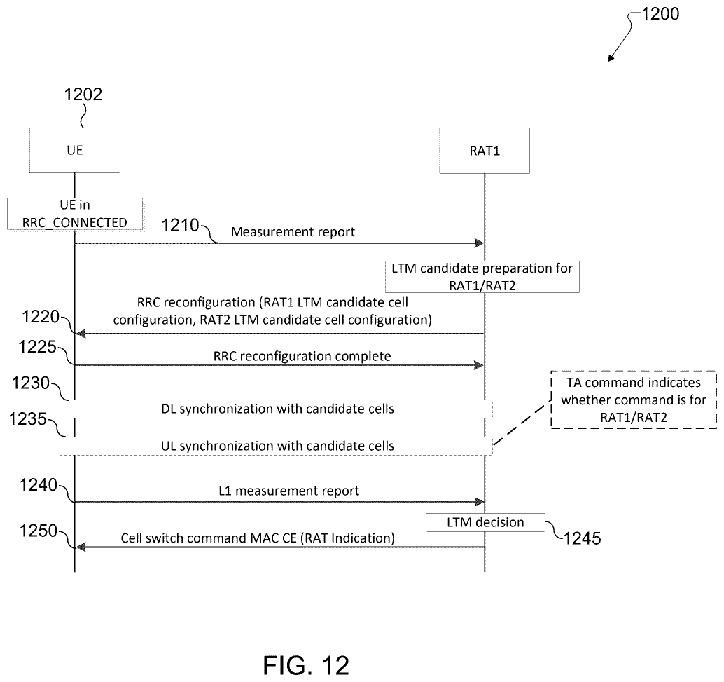

FIG. 12 illustrates an example procedure 1200 for inter RAT LTM according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for inter RAT LTM could be used without departing from the scope of this disclosure.

In the example of FIG. 12, a UE 1202 is in an RRC_CONENCTED mode in a cell (PCell) of a first RAT “RAT1”. At operation 1210, UE 1202 performs measurements (L1 and/or L3) of one or more cells/frequencies of a second RAT “RAT2” and reports the measurement results to the source base station/cell of the first RAT. In some embodiments, UE 1202 may also perform measurements (L1 and/or L3) of one or more cells/frequencies of the first RAT and report the measurement results to source base station/cell of the first RAT at operation 1210. The first RAT can be NR, LTE or 6G, or any other RAT. The second RAT is different from the first RAT and can be NR, LTE or 6G, or any other RAT different from the first RAT. For example, if the first RAT is NR, the second RAT can be LTE, 6G, or any other RAT that isn't NR. In another example, if the first RAT is 6G, the second RAT can be NR, LTE, or any other RAT that isn't 6G.

At operation 1215, the source base station of the cell of the first RAT sends a request to the base station of the second RAT for LTM candidate cell configuration of one or more second RAT's LTM candidate cells and receives the configuration (which includes a RACH configuration for early UL sync, RRCReconfiguration to be applied upon switching, L1 measurement configuration, CG configuration for RACH less switching, etc.) from the base station of the second RAT. The Source base station of the cell of the first RAT may send a request to the base station of the first RAT for an LTM candidate cell configuration of the first RAT's LTM candidate cells and receive the configuration from the base station of the first RAT.

At operation 1220, the source base station/cell of the first RAT signals (e.g., in a RRCReconfiguration message) the LTM candidate cell configuration of one or more LTM candidate cells of the second RAT to UE 1202. The source base station/cell of the first RAT may signal (e.g., in the RRCReconfiguration message) an LTM candidate cell configuration of one or more LTM candidate cells of the first RAT to UE 1202. The list of LTM candidate cells of the first RAT and the second RAT can be separately signaled. In some embodiments, an LTM configuration index is unique within a list of the LTM candidate cells of a RAT. Alternatively, in some embodiments, the list of LTM candidate cells can be common for both the first RAT and the second RAT. For each LTM candidate cell's configuration in the list, it is indicated whether the LTM candidate cell belongs to the first RAT or the second RAT. The LTM configuration index is unique across the LTM candidate cells of both the first and second RAT.

At operation 1225, the UE 1202 acknowledges the reception of the configuration by sending an RRCReconfigurationComplete message to the source base station/cell of the first RAT.

At operation 1230, the UE 1202 may perform DL synchronization with the LTM candidate cell(s) of the second RAT before receiving a cell switch command (e.g., at operation 1250). The UE 1202 may activate and deactivate TCI states of the LTM candidate cell(s) of the second RAT, as triggered by the source base station/cell of the first RAT. The candidate cell(s) and associated RAT for the TCI states that are activated/deactivated are identified by the UE 1202 based on a RAT indication and/or LTM configuration index included in the signaling to activate/deactivate the TCI state(s) of the LTM candidate cell(s).

At operation 1230, the UE 1202 may perform DL synchronization with the LTM candidate cell(s) of the first RAT before receiving a cell switch command (e.g., at operation 1250). The UE 1202 may activate and deactivate TCI states of the LTM candidate cell(s) of the first RAT, as triggered by the source base station/cell of the first RAT. The candidate cell(s) and associated RAT for the TCI states that are activated/deactivated are identified by the UE 1202 based on a RAT indication and/or LTM configuration index included in the signaling to activate/deactivate the TCI state(s) of the LTM candidate cell(s).

The signaling to activate/deactivate TCI state(s) of LTM candidate cell(s) received from the first RAT indicate whether activation/deactivation of TCI states is for the first RAT or the second RAT and the signaling may also indicate an LTM candidate cell by including the LTM configuration index wherein the LTM configuration index can be unique amongst the LTM candidate cells of a RAT, or the LTM configuration index can be unique across the LTM candidate cells of both the first and second RAT.

At operation 1235, the UE 1202 may perform UL synchronization with LTM candidate cell(s) of the second RAT before receiving a cell switch command (e.g., at operation 1250), by using a UE-based TA measurement, if configured, and/or by transmitting a preamble towards the candidate cell of the second RAT, as triggered by a PDCCH order for early TA from the source base station/cell of the first RAT. The UE 1202 may perform UL synchronization with the LTM candidate cell(s) of the first RAT before receiving a cell switch command (e.g., at operation 1250), by using a UE-based TA measurement, if configured, and/or by transmitting a preamble towards the candidate cell of the first RAT, as triggered by a PDCCH order for early TA from the source base station/cell of the first RAT.

The PDCCH order for early TA may indicate whether the early TA acquisition command is for the first RAT or the second RAT. The PDCCH order for early TA may also indicate the LTM candidate cell by including the LTM configuration index, wherein LTM configuration index can be unique amongst the LTM candidate cells of a RAT, or the LTM configuration index can be unique across the LTM candidate cells of both the first and second RAT.

Upon receiving the early TA command from the source base station/cell of the first RAT for the LTM candidate cell of the second RAT, the UE 1202 transmits a preamble to the LTM candidate cell of the second RAT. The base station of LTM candidate cell of the second RAT receives the preamble and calculates the TA and provides the calculated TA to the source base station/cell of the first RAT.

At operation 1240, the UE 1202 performs L1 measurements on the configured LTM candidate cell(s) of the first RAT and the second RAT and transmits L1 measurement reports to the source base station/cell of the first RAT.

At operation 1245, the source base station/cell of the first RAT decides to execute a cell switch to a target cell and at operation 1250 transmits an LTM cell switch command (e.g., a MAC CE, PDCCH, RRC message, etc.) triggering the cell switch. The LTM cell switch command may include a TA of a target cell. The LTM cell switch command indicates whether the target cell belongs to the first RAT or the second RAT and a configuration index of the target cell. In some embodiments, the configuration index in the LTM cell switch command refers to the first RAT's LTM configuration list if the target cell belongs to the first RAT, or the second RAT's LTM configuration list if the target cell belongs to the second RAT. Alternately, in some embodiments, the LTM configuration list can be common for both the first and second RAT. For each LTM candidate cell configuration in the list, it is indicated whether the LTM candidate cell belongs to the first RAT or the second RAT.

If the LTM cell switch command indicates for the UE 1202 to switch to the target cell of the second RAT, the UE 1202 switches to the target cell of the second RAT and applies the candidate configuration of the target cell of the second RAT. If TA is available for the target cell of the second RAT, the UE 1202 can perform a RACH less inter RAT cell switch. If the LTM cell switch command indicates for the UE 1202 to switch to a target cell of the first RAT, UE 1202 switches to the target cell of the first RAT and applies the candidate configuration of the target cell of the first RAT.

The source base station/cell of the first RAT informs the base station of the second RAT when/after it decides to execute the cell switch to a target cell of the second RAT. The information may include a TCI state indicated in the LTM cell switch command MAC CE.

In some embodiments, the target cell of the second RAT may have the same TA as the source cell of the first RAT. The network (e.g., source base station) can indicate to UE 1202 to use the TA of the source cell of the first RAT for the target cell of the second RAT and vice versa.

Information can be exchanged between the base station of the first RAT and second RAT over a direct interface between them or via another entity such as an AMF, interworking function, etc.

Although FIG. 12 illustrates one example procedure 1200 for inter RAT LTM, various changes may be made to FIG. 12. For example, while shown as a series of operations, various operations in FIG. 12 could overlap, occur in parallel, occur in a different order, occur any number of times, be omitted, or replaced by other operations.

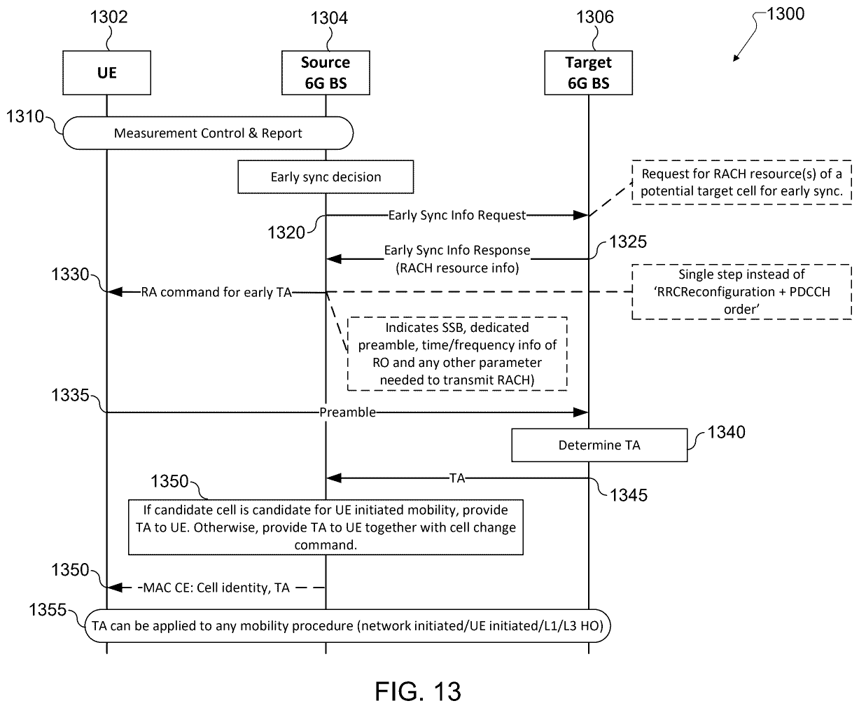

FIG. 13 illustrates an example early TA procedure 1300 applicable for any type of cell switch according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of an early TA procedure applicable for any type of cell switch could be used without departing from the scope of this disclosure.

In the example of FIG. 13, procedure 1300 begins at operation 1310. At operation 1310, a UE 1302 performs measurement of candidate cells/frequencies and reports the measurements to a source base station/cell 1304.

At operation 1315, source base station/cell 1304 decides to trigger early uplink synchronization for one or more cells.

At operation 1320, source base station/cell 1304 sends an early uplink sync information request to one or more target base stations/cells 1306 to request for RACH resources/configuration for early sync.

At operation 1325, the target base station/cells 1306 send early uplink sync information response to source base station/cell 1304, wherein the response includes RACH resources/configuration for early sync.

At operation 1330, source base station/cell 1304 sends a random access command for early TA to UE 1302. The command includes an SSB, dedicated preamble, time/frequency info of RO(s) and any other parameter needed to transmit a random access preamble. The command indicates the candidate cell to which UE 1302 needs to transmit the random access preamble.

At operation 1335, UE 1302 transmits the random access preamble to the candidate cell 1306 indicated in the random access command.

At operation 1340, the candidate cell 1306 determines/calculates the TA based on the received preamble from UE 1302.

At operation 1345, the candidate cell/base station 1306 provides the TA to the source base station/cell 1304.

At operation 1350, if the candidate cell is the candidate for UE initiated mobility, the source base station/cell 1304 provides the TA to UE 1302. For example, a MAC CE or another signaling message can be used for this. The MAC CE or signaling message includes the TA and associated cell info (e.g., cell identity/frequency). Otherwise, source base station/cell 1304 provides the TA to UE 1302 together with a cell change command.

At operation 1350, UE 1302 stores the receives TA info. When a cell switch is triggered due to any mobility procedure (e.g., network initiated L3 handover, UE initiated L3 handover [CHO], network initiated L1/L2 handover, UE initiated L1/L2 handover etc.) and UE 1302 has a valid TA value for the target cell 1306, the UE applies the TA and performs a RACH less cell switch.

Although FIG. 13 illustrates one example early TA procedure 1300 applicable for any type of cell switch, various changes may be made to FIG. 13. For example, while shown as a series of steps, various steps in FIG. 13 could overlap, occur in parallel, occur in a different order, occur any number of times, be omitted, or replaced by other steps.

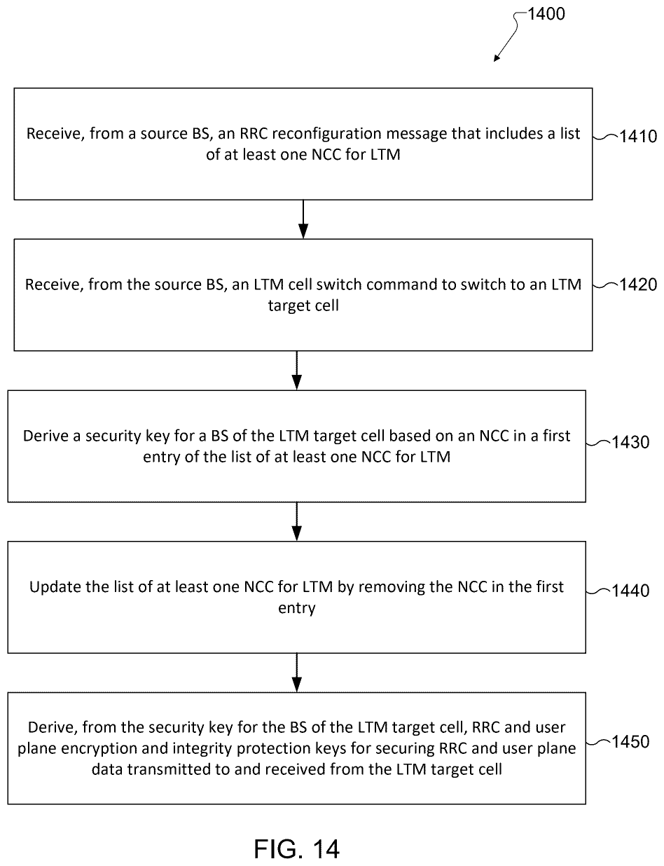

FIG. 14 illustrates an example method 1400 for handling security keys for LTM according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for handling security keys for LTM could be used without departing from the scope of this disclosure.

In the example of FIG. 14, method 1400 begins at step 1410. At step 1410, a UE (such as UE 602) receives, from a source BS (such as gNB 604), an RRC reconfiguration message that includes a list of at least one NCC for LTM.

At step 1420, the UE receives, from the source BS, an LTM cell switch command to switch to an LTM target cell.

At step 1430, the UE derives a security key for a BS of the LTM target cell based on an NCC in a first entry of the list of at least one NCC for LTM.

At step 1440, the UE updates the list of at least one NCC for LTM by removing the NCC in the first entry.

At step 1450, the UE derives, from the security key for the BS of the LTM target cell, RRC and user plane encryption and integrity protection keys for securing RRC and user plane data transmitted to and received from the LTM target cell.

In some embodiments, the LTM cell switch command may include an NCC, and the UE may derive the security key for the BS of the LTM target cell based on the NCC included in the LTM cell switch command. In some embodiments, the UE may determine whether the NCC included in the LTM cell switch command is identical to an NCC of a security key for the source BS, and the security key for the BS of the LTM target cell may be derived based on a result of the determination. In response to a determination that the NCC received in the LTM cell switch command is not identical to the NCC of the security key for the source BS, the UE may derive a NH corresponding to the NCC included in the LTM cell switch command, and derive the security key for the BS of the LTM target cell from the NH. In response to a determination that the NCC included in the LTM cell switch command is identical to the NCC of the security key for the source BS, the UE may derive the security key for the BS of the LTM target cell from the security key for the source base station.

Although FIG. 14 illustrates one example method 1400 for handling security keys for LTM, various changes may be made to FIG. 14. For example, while shown as a series of steps, various steps in FIG. 14 could overlap, occur in parallel, occur in a different order, occur any number of times, be omitted, or replaced by other steps.

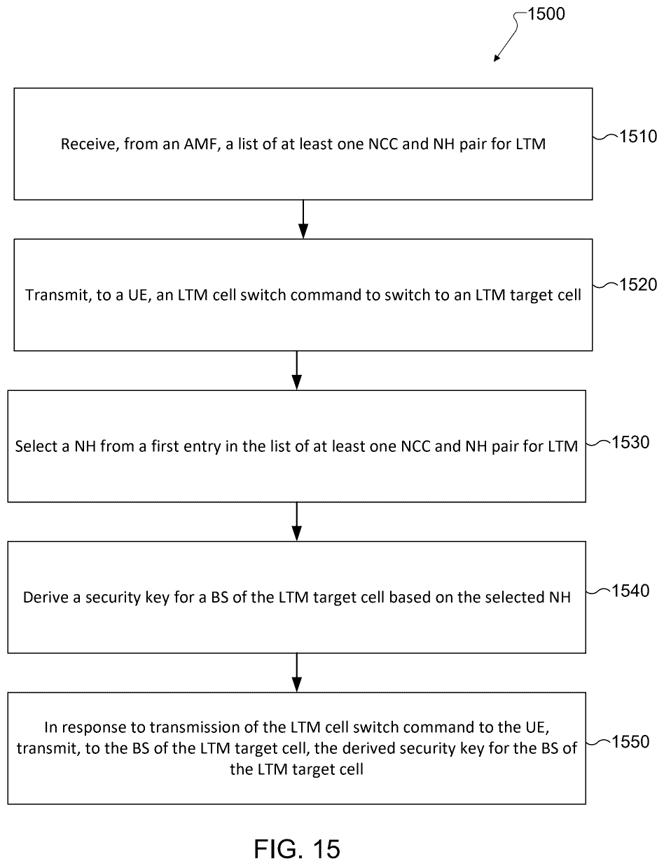

FIG. 15 illustrates another example method 1500 for handling security keys for LTM according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for handling security keys for LTM could be used without departing from the scope of this disclosure.

In the example of FIG. 15, method 1500 begins at step 1510. At step 1510, a source BS (such as gNB 604) receives, from an AMF, a list of at least one NCC and NH pair for lower LTM.

At step 1520, the source BS transmits, UE (such as UE 602), an LTM cell switch command to switch to an LTM target cell.

At step 1530, the source BS selects a NH from a first entry in the list of at least one NCC and NH pair for LTM.

At step 1540, the source BS derives a security key for a BS of the LTM target cell based on the selected NH.

At step 1550, in response to transmission of the LTM cell switch command to the UE, the source BS transmits, to the BS of the LTM target cell, the derived security key for the BS of the LTM target cell. The derived security key for the BS of the LTM target cell is for derivation of, by the LTM target cell, RRC and user plane encryption and integrity protection keys used to protect RRC and user plane data transmitted to and received from the UE.

In some embodiments, the source BS may, after deriving the security key for the BS of the LTM target cell, remove the first entry from the list of at least one NCC and NH pair to generate an updated list, and transmit, to the LTM target cell, the updated list. In some embodiments, the source BS may transmit to the UE, prior to transmission of the LTM cell switch command, an RRC reconfiguration message including a list of at least one NCC for LTM.

In some embodiments, the LTM cell switch command may include an NCC corresponding with the first entry of the list of at least one NCC and NH pair. In some embodiments, the NH is an unused NH, the source BS determines whether the unused NH is available, and the security key for the BS of the LTM target cell is derived based on a result of the determination. In response to a determination that the unused NH is not available, the BS may derive the security key for the BS of the LTM target cell using a security key for the source BS. In response to a determination that the unused NH is available, the BS may derive the security key for the BS of the LTM target cell using the unused NH. In some embodiments, the LTM cell switch command may include an NCC.

Although FIG. 15 illustrates one example method 1500 for handling security keys for LTM, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a source base station (BS), a radio resource control (RRC) reconfiguration message that includes a list of at least one next hop chaining counter (NCC) for lower layer triggered mobility (LTM); and
receive, from the source BS, an LTM cell switch command to switch to an LTM target cell; and
a processor operably coupled to the transceiver, the processor configured to, in response to receipt of the LTM cell switch command:
derive a security key for a BS of the LTM target cell based on an NCC in a first entry of the list of at least one NCC for LTM;
update the list of at least one NCC for LTM by removing the NCC in the first entry; and
derive, from the security key for the BS of the LTM target cell, RRC and user plane encryption and integrity protection keys for securing RRC and user plane data transmitted to and received from the LTM target cell.

2. The UE of claim 1, wherein:
the LTM cell switch command includes an NCC; and
the processor is further configured to:
derive the security key for the BS of the LTM target cell based on the NCC included in the LTM cell switch command.

3. The UE of claim 2, wherein:
the processor is further configured to determine whether the NCC included in the LTM cell switch command is identical to an NCC of a security key for the source BS; and
the security key for the BS of the LTM target cell is derived based on a result of the determination.

4. The UE of claim 3, wherein the processor is further configured to, in response to a determination that the NCC received in the LTM cell switch command is not identical to the NCC of the security key for the source BS:
derive a next hop (NH) corresponding to the NCC included in the LTM cell switch command; and
derive the security key for the BS of the LTM target cell from the NH.

5. The UE of claim 3, wherein the processor is further configured to, in response to a determination that the NCC included in the LTM cell switch command is identical to the NCC of the security key for the source BS, derive the security key for the BS of the LTM target cell from the security key for the source base station.

6. A source base station (BS) comprising:
a transceiver configured to:
receive, from an access and mobility function (AMF), a list of at least one next hop chaining counter (NCC) and next hop (NH) pair for lower layer triggered mobility (LTM); and
transmit, to a user equipment (UE), an LTM cell switch command to switch to an LTM target cell; and
a processor operably coupled to the transceiver, the processor configured to:
select NH from a first entry in the list of at least one NCC and NH pair for LTM;
derive a security key for a BS of the LTM target cell based on the selected NH; and
in response to transmission of the LTM cell switch command to the UE, cause the transceiver to transmit, to the BS of the LTM target cell, the derived security key for the BS of the LTM target cell,
wherein the derived security key for the BS of the LTM target cell is for derivation of, by the LTM target cell, radio resource control (RRC) and user plane encryption and integrity protection keys used to protect RRC and user plane data transmitted to and received from the UE.

7. The source BS of claim 6, wherein:
the processor is further configured to:
after deriving the security key for the BS of the LTM target cell, remove the first entry from the list of at least one NCC and NH pair to generate an updated list; and
cause the transceiver to transmit, to the LTM target cell, the updated list.

8. The source BS of claim 7, wherein:
the transceiver is further configured to transmit, to the UE, prior to transmission of the LTM cell switch command, an RRC reconfiguration message including a list of at least one NCC for LTM.

9. The source BS of claim 6, wherein the LTM cell switch command includes an NCC corresponding with the first entry of the list of at least one NCC and NH pair.

10. The source BS of claim 6, wherein:
the NH is an unused NH;
the processor is further configured to determine whether the unused NH is available; and
the security key for the BS of the LTM target cell is derived based on a result of the determination.

11. The source BS of claim 10, wherein the processor is further configured to, in response to a determination that the unused NH is not available, derive the security key for the BS of the LTM target cell using a security key for the source BS.

12. The source BS of claim 10, wherein the processor is further configured to, in response to a determination that the unused NH is available, derive the security key for the BS of the LTM target cell using the unused NH.

13. The source BS of claim 10, wherein the LTM cell switch command includes an NCC.

14. A method of operating a user equipment (UE), the method comprising:
receiving, from a source base station (BS), a radio resource control (RRC) reconfiguration message that includes a list of at least one next hop chaining counter (NCC) for lower layer triggered mobility (LTM);
receiving, from the source BS, an LTM cell switch command to switch to an LTM target cell;
deriving a security key for a BS of the LTM target cell based on an NCC in a first entry of the list of at least one NCC for LTM;
updating the list of at least one NCC for LTM by removing the NCC in the first entry; and
deriving, from the security key for the BS of the LTM target cell, RRC and user plane encryption and integrity protection keys for securing RRC and user plane data transmitted to and received from the LTM target cell.

15. The method of claim 14, wherein:
the LTM cell switch command includes an NCC; and
the method further comprises deriving the security key for the BS of the LTM target cell based on the NCC included in the LTM cell switch command.

16. The method of claim 15, further comprising:
determining whether the NCC included in the LTM cell switch command is identical to an NCC of a security key for the source BS,
wherein the security key for the BS of the LTM target cell is derived based on a result of the determination.

17. The method of claim 16, further comprising, in response to a determination that the NCC received in the LTM cell switch command is not identical to the NCC of the security key for the source BS:
deriving a next hop (NH) corresponding to the NCC included in the LTM cell switch command; and
deriving the security key for the BS of the LTM target cell from the NH.

18. The method of claim 16, further comprising, in response to a determination that the NCC included in the LTM cell switch command is identical to the NCC of the security key for the source BS, deriving the security key for the BS of the LTM target cell from the security key for the source base station.

19. A method of operating a source base station (BS), the method comprising:
receiving, from an access and mobility function (AMF), a list of at least one next hop chaining counter (NCC) and next hop (NH) pair for lower layer triggered mobility (LTM);
transmitting, to a user equipment (UE), an LTM cell switch command to switch to an LTM target cell;
selecting a NH from a first entry in the list of at least one NCC and NH pair for LTM;
deriving a security key for a BS of the LTM target cell based on the selected NH; and
in response to transmission of the LTM cell switch command to the UE, transmitting, to the BS of the LTM target cell, the derived security key for the BS of the LTM target cell,
wherein the derived security key for the BS of the LTM target cell is for derivation of, by the LTM target cell, radio resource control (RRC) and user plane encryption and integrity protection keys used to protect RRC and user plane data transmitted to and received from the UE.

20. The method of claim 19, further comprising:
after deriving the security key for the BS of the LTM target cell, removing the first entry from the list of at least one NCC and NH pair to generate an updated list; and
transmitting, to the LTM target cell, the updated list.

21. The method of claim 20, further comprising transmitting, to the UE, prior to transmission of the LTM cell switch command, an RRC reconfiguration message including a list of at least one NCC for LTM.

22. The method of claim 19, wherein the LTM cell switch command includes an NCC corresponding with the first entry of the list of at least one NCC and NH pair.

23. The method of claim 19, wherein:
the NH is an unused NH;
the method further comprises determining whether the unused NH is available; and
the security key for the BS of the LTM target cell is derived based on a result of the determination.

24. The method of claim 23, further comprising, in response to a determination that the unused NH is not available, deriving the security key for the BS of the LTM target cell using a security key for the source BS.

25. The method of claim 23, further comprising, in response to a determination that the unused NH is available, deriving the security key for the BS of the LTM target cell using the unused NH.

26. The method of claim 23, wherein the LTM cell switch command includes an NCC.
